(19) United States
(12) Patent Application Publication
(10) Pub. No.: US 2016/0027319 A1
(43) Pub. Date: Jan. 28, 2016

(54) SYSTEM AND METHOD FOR AUTOMATIC GENERATION OF INTERACTIVE EDUCATIONAL APPLICATIONS

(71) Applicant: Slate Science Inc., New York, NY (US)

(72) Inventor: Samuel LONDON, Zichron Yaakov (IL)

(21) Appl. No.: 14/339,551

(22) Filed: Jul. 24, 2014

(51) Int. Cl. G09B 7/02; G09B 23/02; G06F 17/10

(52) U.S. Cl. CPC G09B 7/02; G06F 17/10; G09B 23/02

(57) ABSTRACT

A method for automatically creating an interactive educational application that presents a customized instance of a class of problem in the fields of science, technology, engineering, and mathematics to a learner. An educator uses a development platform running on a computing device. The educator selects a particular class of problem and is then presented with a set of parameters for customization of the selected problem. Parameters of created instances input by the educator include the number of instances of the problem presented to the learner, along with values and rules for values of certain variables of the problem. Problem classes also include graphical elements for display and manipulation by the learner in conjunction with solving the presented problem. Created instances of the problems are output from the development device as interactive educational applications that run on a computing device of the learner or on a remote server over the Internet.

### FIELD OF THE INVENTION

This application relates to educational software, and in particular to the automatic generation of instances of a game for learning math based on a limited number of instructions from a creator of the game.

### BACKGROUND

The development of educational software is becoming increasingly more complex and expensive. In an era of tablets and smartphones, educational software is expected to be highly graphical, engaging, and interactive. Developing educational software products is similar to producing computer games, requiring significant investment and development expertise.

Educational software products involve a unique layer of complexity, due to their educational mission. In addition to staging captivating game-like simulations, the software typically engages students in a series of problems and solutions. The resulting interactions are potentially complex and asynchronous, involving random problem generation, student error diagnostics, hints, feedback, scoring, and behind-the-scene record maintenance and analysis.

Currently, developers of educational software need to create their products using general-purpose graphical development platform environments. This can be a time-consuming process, because each product needs to be developed from scratch or from a low-level generic template, which may require considerable work to modify and customize.

Instead, it would be highly advantageous and desirable to have a specialized development platform environment which is suited for an educator without software skills to create interactive educational applications, to allow rapid production of finished software applications for teaching and learning, by automatically generating interactive educational application according to concise rule and parameter input.

### SUMMARY

Embodiments of the present invention provide methods for an educator to automatically generate interactive educational software applications (also referred to as “apps”) which present learners (e.g., humans, students, etc.) with a predetermined number of different variations of a selected class of problems to solve. The term “problem” herein denotes any learner-solvable problem in the fields of science, technology, engineering, and mathematics. The term “learner-solvable” herein denotes that a typical learner who would use the interactive educational application can be expected to be capable of solving the problem.

Learners' solutions are automatically verified for correctness, and their scores are reported and tabulated, and the learner is informed of the results of verifying his or her solutions.

The term “automatically-generate” herein denotes that an interactive educational application is produced by an automated process based on a predefined software template for a specified problem. The educator selects the particular problem and chooses values (and/or rules for values) for certain parameters of the problem that would be appropriate for the learner(s) who will be interactively working with the problem. In this manner, the educator may customize the problem on an individualized basis. The educator is not required to perform any programming or programming-related operations—the programming has already been done in creating the predefined template for the problem. According to various embodiments of the invention, the predefined templates include both the dynamic presentation of the problem and the acceptance and evaluation of solutions from the learner, as well as include suitable interactive graphics.

Descriptions of the invention embodiments presented herein are expressed in non-limiting terms of an object-oriented paradigm. Embodiments of the present invention can be implemented on any suitable software development platform environment and are not limited to object-oriented development platforms. The object-oriented paradigm, however, is well-suited for expressing and understanding the invention's embodiments, particularly relating to object-oriented concepts such as class-instance differentiation, subclassing and inheritance, encapsulation, polymorphism, common object models, the messaging metaphor, and reusability issues. In the examples and illustrations, object-oriented pseudo code expressions are framed in terms of the well-known Smalltalk model, with some minor changes for clarification, including the following:
static data object containers normally referred to as “variables” are herein denoted by the term “parameters”; and
dynamic executable code objects normally referred to as “methods” in the object-oriented paradigm are herein denoted by the term “actions”, to clearly distinguish them from the inventive processes generally referred to as “methods” disclosed in the specification and recited in the claims.

Therefore, according to an embodiment of the present invention there is provided a method for automatically generating one or more instances of a predefined class of problem, the method comprising: (a) receiving, by a first computing device, at least one input parameter at least partially defining an instance of the predefined class; (b) responsively to the receiving, automatically generating, by the first computing device, at least one instance of the predefined class, according to the at least one input parameter, wherein: (c) the at least one instance includes executable code stored in a non-transitory storage, such that when the executable code is executed by a second computing device, the executable code causes the second computing device to: (d) present the at least one instance to a learner via the second computing device; (e) prompt the learner to enter at least one solution to the at least one instance; and (f) if the learner enters the at least one solution, automatically verify a correctness of the at least one solution.

In addition, according to another embodiment of the present invention there is provided a computing device product for a development platform, comprising a non-transitory storage medium containing executable code for a first computing device, wherein the executable code, when executed by the first computing device, causes the computing device to perform: (a) receiving, by the first computing device, at least one input parameter at least partially defining an instance of the predefined class; (b) responsively to the receiving, automatically generating, by the first computing device, at least one instance of the predefined class, according to the at least one input parameter, wherein: (c) the at least one instance includes executable code stored in a non-transitory storage, such that when the executable code is executed by a second computing device, the executable code causes the second computing device to: (d) present the at least one instance to a learner via the second computing device; (e) prompt the learner to enter at least one solution to the at least one instance; and (f) if the learner enters the at least one solution, automatically verify a correctness of the at least one solution.

### BRIEF DESCRIPTION OF THE DRAWINGS

The subject matter disclosed may best be understood by reference to the following detailed description when read with the accompanying drawings in which:

FIG. 1 conceptually illustrates a screen display of an automatically-generated interactive educational application for a non-limiting example of a problem according to an embodiment of the present invention.

FIG. 2 conceptually illustrates the educator/learner environments according to an embodiment of the present invention.

FIG. 3 is a flowchart of a method for presenting a problem to a learner by an interactive educational application running on a computing device, according to an embodiment of the present invention.

FIG. 4 conceptually illustrates fundamental properties of some core object classes related to the non-limiting example of FIG. 1, according to an object-oriented description of an embodiment of the present invention.

FIG. 5 is a flowchart of a method executed by a computing device hosting a development platform for automatically generating an interactive educational application according to an embodiment of the present invention.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “comparing”, “designating,” “allocating” “compiling a list”, “assemble a table” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions, upon execution by for example a processor or group of processors, result in a method of an embodiment of the invention.

The following describes and illustrates the environment and general operation of an automatically-generated interactive educational application from a learner's perspective, according to an embodiment of the present invention.

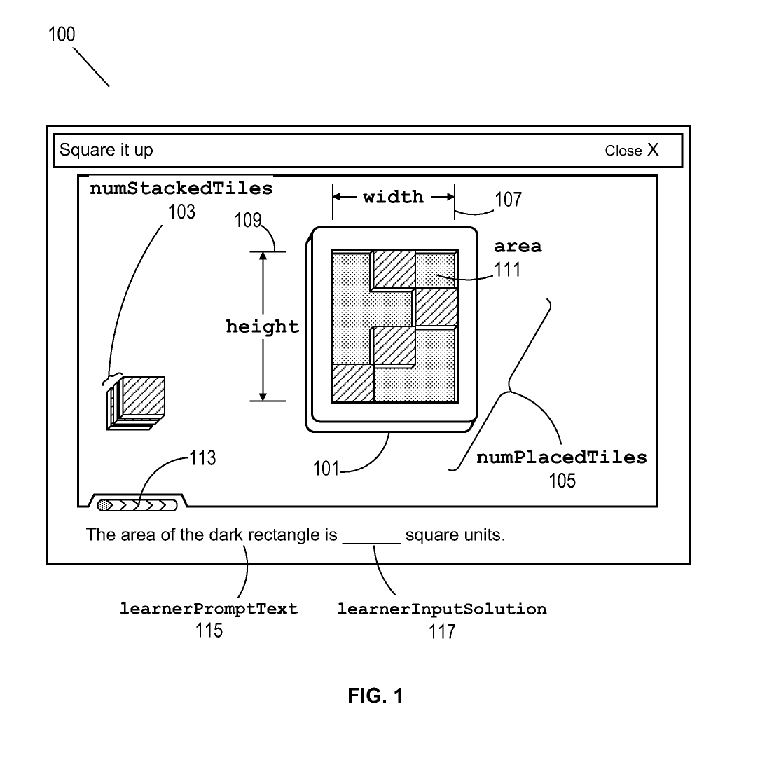

FIG. 1 conceptually illustrates a screen display 100 of an automatically-generated interactive educational application for a non-limiting example of a problem according to an embodiment of the present invention. A predetermined number of instances of the general problem is presented or displayed (e.g., on a monitor) to a learner who attempts to solve the problem for each instance.

This particular non-limiting example deals with teaching and learning how to compute rectangle areas. Other problems can be learned. The various parameters and rules are used to create problem instances that give different and various visual hints about the relationship between the number of tiles and the rectangle's area. In one example, when the number of available tiles equal width*height, the learner can use the tiles to cover the entire rectangle, and then count the number of tiles used. In another example, when there are fewer tiles available, the learner can tile only parts of the rectangle's area. The resulting partial tiling creates a visual effect that can motivate the learner to account for the missing tiles mentally, until at some point he or she learns how to use multiplication and other algebraic manipulations to compute the geometric area. These are typical examples of how embodiments of the invention use randomization and object manipulation (in this case, using the tiles) for hands-on self-discovery of mathematical subjects. It is also important to note that the educator who has generated the particular instances of the problem can use the system to create additional variants of the same problem, such as for more advanced learners.

FIG. 1 and the accompanying description are with respect to the particular non-limiting example shown, which deals with computing the area of rectangles using tiling operations. Other problems are different and have different graphical representations, and the illustrations and descriptions are correspondingly different from those of the particular non-limiting example shown here.

In screen display 100 is a graphical representation of a frame 101 with a central darkened rectangle 111 having an area symbolically represented by a parameter area. Rectangle 111 has a width 107 and a height 109, which are symbolically represented by parameters width and height, respectively. A graphical representation of a bank of identical square tiles 103 is near frame 101, for graphical manipulation by the learner. The number of tiles initially in the bank is symbolically represented by a parameter numBankedTiles. The number of tiles initially placed in rectangle 111 is symbolically represented by a parameter numPlacedTiles. The parameters width and height are expressed in integer units equal to the side of a square tile, and the parameter area is expressed in integer units of square tiles.

Learner prompt text 115 is displayed to the learner as a cue or request to solve the problem. The learner enters a solution in field 117. The learner prompt text is symbolically represented by a parameter learnerPromptText, and the solution entered by the learner is symbolically represented by a parameter learnerInputSolution. A progress bar 113 shows the learner which instance he or she is currently working on. As with other aspects of the invention, on-screen input and manipulation (e.g., dragging) may be performed using, for example, a pointing device such as a mouse or touch-screen, allowing a user to manipulate on-screen items (e.g., drag, click, etc.), keyboard, etc.

As indicated by learner prompt text 115, the learner is to solve the problem by entering the area of rectangle 111 as an integer indicating how many tiles are needed to fill rectangle 111. Initially, rectangle 111 is partially filled with tiles 105 to provide a visual clue about area computation to the learner. If the learner wishes to continue to solve the problem visually, he or she can drag one or more tiles from bank 103 into empty regions of rectangle 111. In some instances of the problem, there are enough tiles in bank 103 along with tiles 105 to completely fill rectangle 111, in which case the learner need only count the number of tiles in filled rectangle 111 to solve the problem. In other instances, however, there may not be enough tiles to completely fill rectangle 111, so the learner has to solve the problem in other ways, such as by multiplying width 107 by height 109 to obtain the area, i.e., area equals width*height.

Once again, the non-limiting example above is provided for illustrative purposes only. In general, any solvable problem along with suitable graphics and interactive manipulation of graphical objects can be presented or displayed (e.g., on a monitor) by an automatically-generated interactive educational application according to various embodiments of the present invention, as disclosed further below.

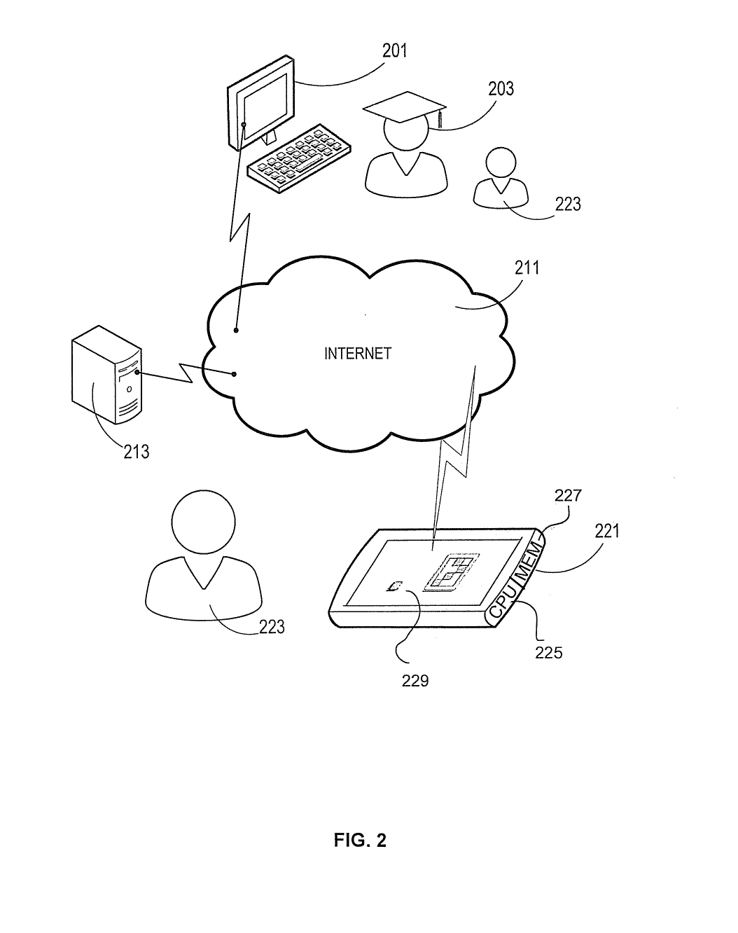

FIG. 2 conceptually illustrates the environments of an educator 203 and a learner 223 according to various embodiments of the present invention.

In one embodiment educator 203 uses a computing device 201 to automatically generate interactive educational applications which run on a computing device 221 used by learner 223. A network 211 (such as the Internet) is employed to deliver interactive educational applications generated on educator 203's computing device 201 to learner 223's computing device 221.

In another embodiment, a remote network server 213 which may include one or more processors and memory units automatically generates interactive educational applications for educator 203. In a related embodiment, the interactive educational applications 229 run on remote network server 213 using learner 223's computing device 221 which may include one or more processors 225 and transitory storage or memory units 227, as an input/output terminal.

In a further embodiment, educator 203 accompanies learner 223, and the interactive educational applications run on educator 203's computing device 201.

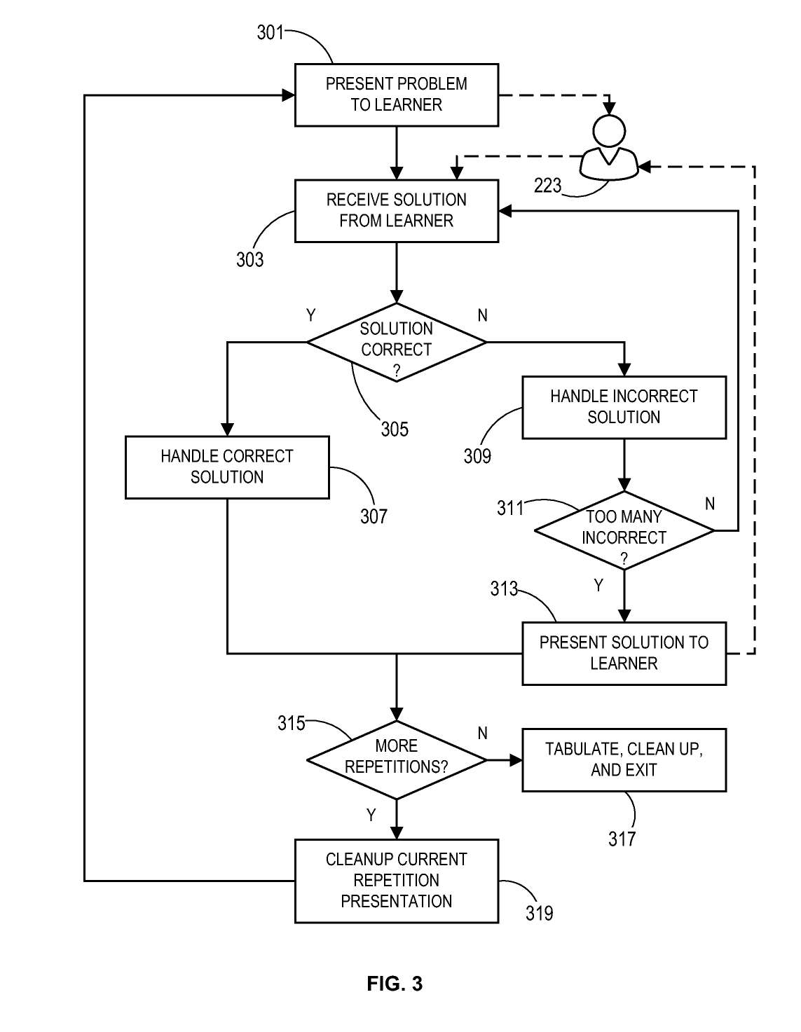

FIG. 3 is a flowchart of a method for presenting or displayed (e.g., on a monitor) a problem to a learner 223 by an interactive educational application running on a computing device (such as computing device 221 or computing device 201 in FIG. 2), according to an embodiment of the present invention. In a step 301 a problem is presented to learner 223. In a step 303, a solution is received from learner 223. At a decision point 305 the solution is verified for correctness. If the solution is correct, a step 307 handles the correct solution. At a decision point 315, if there are more instances of the problem, the current instance presentation (e.g., the graphic display) may be cleared to for example remove items or props that were collected on the display in the course of the prior instances in a step 319, and then step 301 is repeated. If there are no more instances of the current problem, in a step 317, learner 223's results are tabulated, the current problem presentation is cleaned up, and the interactive educational application exits. If, at decision point 305, the solution fails verification for correctness, then a step 309 handles the incorrect solution. At a decision point 311 the number of incorrect solutions is compared against a predetermined threshold, and if the number of incorrect solutions does not exceed the threshold, then step 303 is repeated. If the number of incorrect solutions does exceed the threshold, however, a step 313 presents the correct solution to learner 223, and decision point 315 is then performed.

### Automatically Generating an Interactive Educational Application

The previous discussions and illustrations focus on the nature and operation of the interactive educational applications themselves. The following discussions and illustrations relate to the automatic generation process for interactive educational applications, according to various embodiments of the present invention.

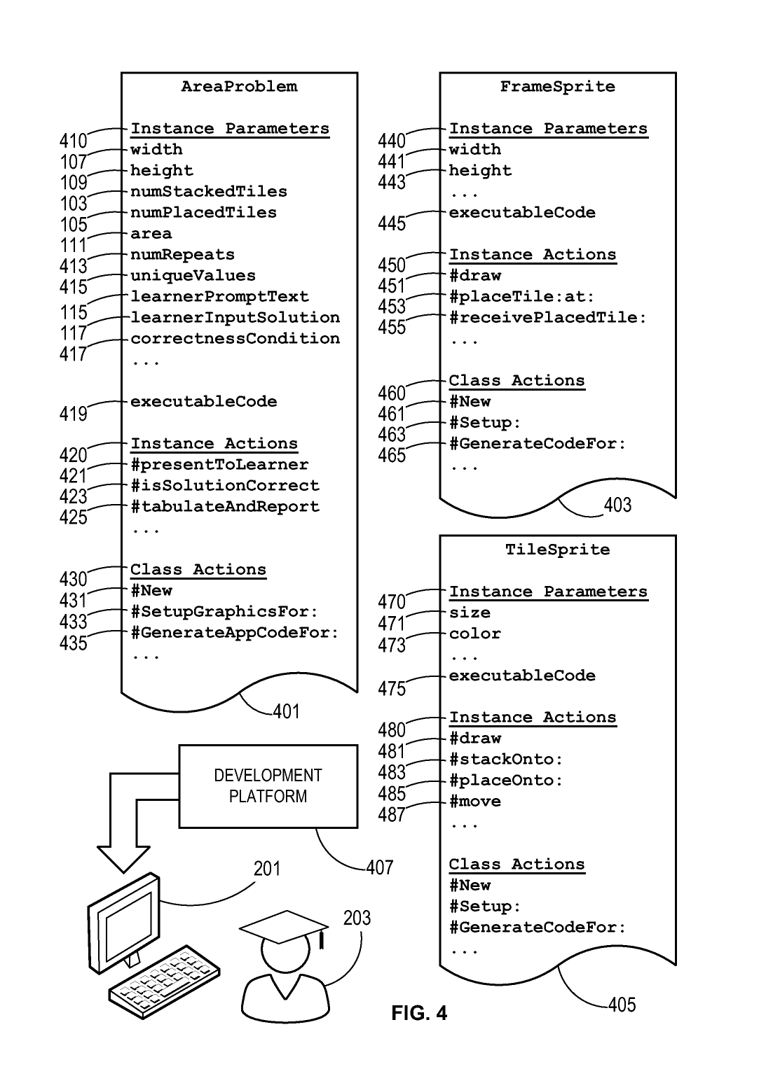

FIG. 4 conceptually illustrates fundamental properties of some predefined core object classes according to an object-oriented description of an embodiment of the present invention. Once again, the illustrations and descriptions show the embodiment for the non-limiting example previously presented. In practice, there are many different predefined classes of problem from which the educator may select for producing an interactive educational application. As noted previously, the educator does not need to create new classes or perform any other programming operations. The educator, however, does specify the particular desired characteristics of the problem to be presented to the learner by the interactive educational application, and the executable code for the application is automatically generated after an instance of the class is created by the development platform, which can run on computing device 201 or alternatively on remote server 213 (FIG. 2).

In an embodiment of the present invention, a single instance of a problem displays multiple versions of the problem to the learner when the learner runs the interactive educational application. In another embodiment, the executable code of the application contains multiple instances, wherein each instance presents a different version of the problem to the learner.

An AreaProblem class 401 is the principal template for the problem of the non-limiting example. Typically, AreaProblem class 401 is defined as a subclass of a more general abstract class MathematicalProblem (not shown), where abstract classes provide common higher-level static variables and dynamic actions, but are generally not instantiated.

In the conceptual descriptions below, only the principal classes, parameters, and actions are described. Other basic supporting classes, parameters, and actions are necessary for implementation, which are generally provided in object-oriented environments by development platforms and are well-known and familiar to those skilled in the art.

For AreaProblem class 401 instance parameters 410 may include the following though other rules or parameters may be included by a teacher or rule formulator:
numRepeats 413, the number of times the application as executed by for example processor 225 or some other processor presents the problem to the learner, specified by educator 203, typically as an integer.
width 107, as previously described, specified by educator 203, typically via a rule, e.g., 2 . . . 7, a randomly chosen integer ranging from 2 to 7.
height 109, as previously described, specified by educator 203, typically via a rule, e.g., 2 . . . 7, a randomly chosen integer ranging from 2 to 7.
numBankedTiles 103, as previously described, specified by educator 203, typically via an ordered collection of rules, one for each of numRepeats 413. In a non-limiting example, let numRepeats:=6, and
   numBankedTiles:=width*height.
   numBankedTiles:=width*height−1.
   numBankedTiles:=width.
   numBankedTiles:=height.
   numBankedTiles:=width−1.
   numBankedTiles:=height−1.
numPlacedTiles 105, as previously described, specified by educator 203, typically via an order collection, similar to that for numBankedTiles.
area 111, as previously described, and generally not set via an input operation by educator 203, but rather computationally set according to the function

area:=width*height. (Equation 1)
uniqueValues 415, specified by educator 203, as a collection (such as an Array) containing symbols for parameters which are to be different for each instance of the problem, For example, suppose educator 203 wants all rectangle widths and heights to be different, then
   uniqueValues:=#[#width#height].
   In this example uniqueValues is an Array whose elements are the parameters #width and #height—not the values held by the parameters, but the symbolic parameters themselves. This provides input to the runtime code of the interactive educational application to insure that different values for these parameters are selected for each presentation of the problem.
learnerPromptText 115, specified by educator 203, as a String, in this non-limiting example
   learnerPromptText:=‘The area of the dark rectangle is ______ square units’.
learnerInputSolution 117, input by learner, is the learner's response to solve the problem.
correctnessCondition 417, specified by educator 203, is a rule which evaluates to a Boolean. In this non-limiting example:
   correctnessCondition:=[learnerInputSolution=width*height]
   The block of code in square brackets is an expression that evaluates to true if the learner has entered the correct answer to the problem, and evaluates to false otherwise.
executableCode 419 is automatically generated by development platform 407, and is the code for the finished interactive educational application. According to an embodiment of the present invention executableCode 419 is native code for the target computing device. In another embodiment, executableCode 419 is not native code for the target computing device, but is run by a virtual machine on the target computing device (e.g., Java).

According to various embodiments of the present invention, educator 203 specifies the parameters indicated above through an interactive process with development platform 407. Educator 203 does not need to write any code or explicitly modify objects. Rather, development platform 407 running on or executed on computing device 201 interactively requests input from educator 203 in a convenient manner, such as via input windows, queries, or other common means.

Dynamic behavior of instances of classes is specified by previously-defined instance actions. These are provided in the classes and are transparent to the educator. Instance actions are called as necessary during runtime by the interactive educational application. For AreaProblem class 401 instance actions 420 include:
#presentToLearner 421—called by each instance of the problem to display the instance according to the educator's choice of parameters. This action is predefined to include a display of the associated graphical elements, as detailed below.
#isSolutionCorrect 423—called after learner responds with a solution, and evaluates the mathematical function in correctnessCondition 417 to determine if the learner's solution is correct.
#tabulateAndReport 425—called to evaluate the learner's overall performance in solving the problem after all instances are complete.

Dynamic behavior of classes is specified by previously-defined class actions. These are provided in the classes and are transparent to the educator. Class actions are called as necessary during development by development platform code 407 when run interactively by educator 203. For AreaProblem class 401 class actions 430 include:
#New 431—creates a new instance of AreaProblem class 401.
#SetupGraphicsFor: 433—incorporates graphical elements into the new instance of AreaProblem class 401. The colon in the action name indicates that the action takes an argument, in this case the argument is the new instance of AreaProblem class 401.
#GenerateAppCodeFor: 436—compiles and outputs executableCode 419 that implements the interactive educational application under development. This is the deliverable product that the learner runs.

### Graphics

Various embodiments of the invention incorporate suitable graphics and interactive manipulation of graphical objects into the finished interactive educational application. Graphical elements are expressed as instances of Sprite classes (or their equivalents), as are commonly found in video games. As with other classes, these are predefined in the development environment and are incorporated into the MathematicalProblem classes. The educator does not have to explicitly incorporate any graphics.

A graphical sprite typically contains executable code that allows the sprite to intelligently interact with its graphical environment, such as by sensing visual proximity to other sprites being displayed on a screen. Another advantage of sprites is that they can inherently encapsulate executable code for animation features, without requiring any additional programming. For example, a sprite having a visual appearance of a bird might be moved on the screen close to a sprite having a visual appearance of a worm, and the worm sprite may automatically wiggle in response to the approach of the bird sprite.

By way of illustration, the two graphical elements of AreaProblem class 401 are FrameSprite class 403 and TileSprite class 405.

FrameSprite class 403 instance parameters 440 include:
width 441, an independent variable with the same name as width 107, and which is set programmatically by action #SetupGraphicsFor: 433 to the same value as width 107.
height 443, an independent variable with the same name as height 109, and which is set programmatically by action #SetupGraphicsFor: 433 to the same value as height 109.
executableCode 445, which contains the executable code for an instance of FrameSprite that implements the behavior of frame 101 (FIG. 1).

For FrameSprite class 403 instance actions 450 include:
#draw 451—called by each instance of the problem to display the frame on the screen according to the parameters width 441 and height 443 programmatically assigned by action #SetupGraphicsFor: 433.
#placeTile:at: 453—called to initialize a frame instance to have a tile placed on it when first displayed (as shown for tiles 105 in FIG. 1). The two colons indicate that this action takes two arguments, a tile sprite object to be placed into the frame as the first argument, and a location in the frame as the second argument.
#receivePlacedTile: 455—called to place an interactively moved tile sprite into the frame. The argument is the tile sprite object that the learner has moved to the frame. The position for the placed tile is sensed by the frame sprite from the graphical location of the tile sprite when the learner places it into the frame.

For FrameSprite class 403 class actions 460 include:
#New 461—creates a new instance of FrameSprite class 403.
#Setup: 463—initializes a newly created instance to graphically have the dimensions on the screen as given by parameters width 441 and height 443.
#GenerateCodeFor: 463—compiles executableCode 445 that implements the frame sprite. This code is incorporated into executableCode 419 as created by #GenerateAppCodeFor: 435.

TileSprite class 405 instance parameters 470 include:
size 471, set programmatically by action #SetupGraphicsFor: 433 to a predetermined size, e.g., in pixels.
color 473, set programmatically by action #SetupGraphicsFor: 433 to a predetermined color.
executableCode 475, which contains the executable code for an instance of TileSprite that implements the behavior of tiles shown in FIG. 1.

For TileSprite class 405 instance actions 480 include:
#draw 481—called for each tile displayed on the screen according to the parameters size 471 and color 473 programmatically assigned by action #SetupGraphicsFor: 433.
#bankOnto: 483—called programmatically by action #SetupGraphicsFor: 433 for a new instance of TileSprite to create a bank of tiles 103 as shown in FIG. 1.
#placeOnto: 485—called programmatically by action #SetupGraphicsFor: 433 for a new instance of TileSprite to place the instance in frame 101 as shown in FIG. 1 by calling #placeTile:at: 453.
#move 487—called when the learner interactively moves the instance of the tile sprite on the screen.

For TileSprite class 405, there are class actions similar to those of FrameSprite class actions 460.

### Development Platform Operation

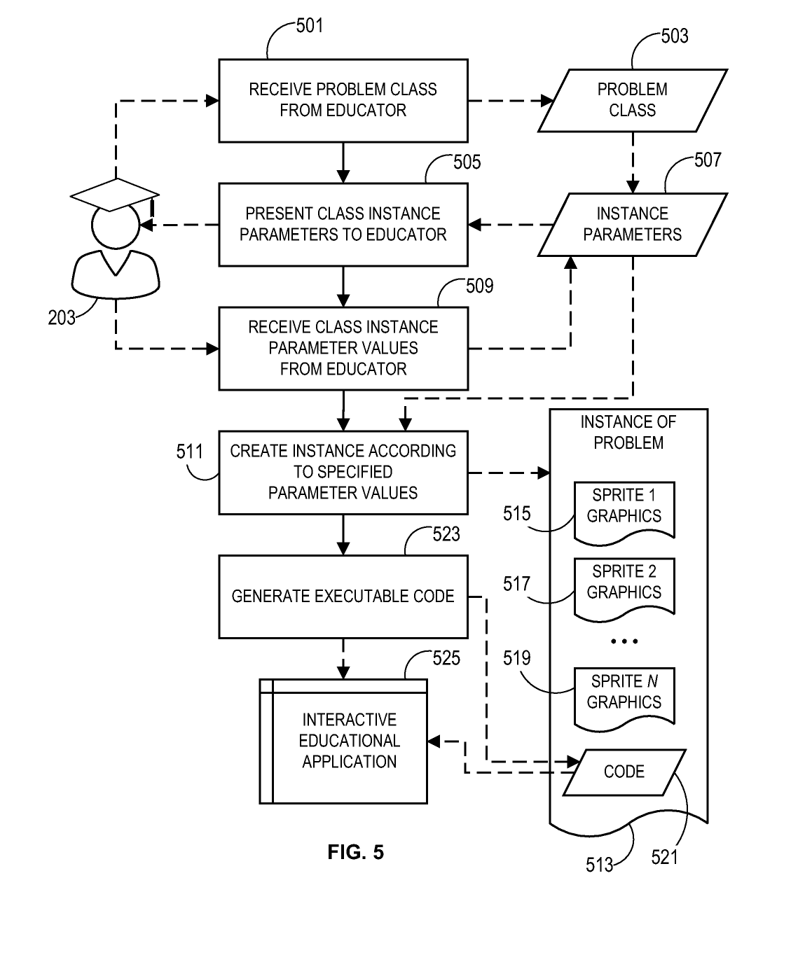

FIG. 5 is a flowchart of a method executed by computing device 201 or remote server 213 (FIG. 2) hosting development platform 407 (FIG. 4) for automatically generating an interactive educational application according to an embodiment of the present invention. In some embodiments, one or more functions may be executed by for example processor 225 with instructions that were stored on memory 227, though other processors and memory units may be used. In a step 501 a problem class 503 is received from educator 203. In the non-limiting examples above, problem class AreaProblem 401 is used, but the number of different problem classes from which educator 203 may choose is, in principle, unlimited. In a step 505, problem class 503 instance parameters 507 are presented to educator 203. Instance parameters 507 are selected instance parameters of problem class 503 whose values (and/or rules for values) are to be specified by educator 203 in order to create a customized instance of problem class 503.

In a step 509 values (and/or rules for values) for instance parameters 507 are received from educator 203, and in a step 511, development platform 407 creates a new instance 513 of problem class 503 according to instance parameters 507. New instance 513 also contains instances of sprite 1 graphics 515, sprite 2 graphics 517, . . . , and sprite N graphics 519 as appropriate for problem class 503.

In a step 523, development platform 407 generates executable code 521 for new instance 513, thereby creating an interactive educational application 525.

Embodiments of the invention may include a method for automatically creating or generating one or more instances of a learning game, where the instances are based on or teach a predefined class of problem such as a math problem. Embodiments of the invention receive as an input to a computing device an example of a class of lessons or games that a teacher may want to impart to a player. Such a predefined class may include for example, calculating a perimeter of a circle or other functions, where a partial definition of the lesson may be circumference=Π*diameter of the circle, or some other math formula or function. A inputted parameter may include an instruction to create a selected number of math game sessions or instances of the game using such formula, or may be a parameter generated randomly. In some embodiments, a computer may in response to the instruction, generate one or more instances of a game or lesson that includes or teaches the rule about circle circumference. Such lesson or game may be created by for example generating code to be stored in a memory, where such code upon execution by for example a student's or learner's computing or media device to present the instance of the game to the student's computer, prompt or request the student to enter at least one solution to the instance of the math game, and if the learned responds, or upon the entering by the student of a solution, to automatically verify as for example correct or incorrect the inputted solution. In some embodiments a processor may report or inform the results of the correct or incorrect answer to the student or player, or may inform some other device of the results of the verifying of the correctness of the answer. In some embodiments, if the learner or student does not respond within a designated period such as a minute or two, the system may prompt the student again, offer hints to the solution or present for example an easier instance of the game or lesson. In some embodiments, each of the generated instances of the game may be unique so that a player is not presented with repeats of the same game. In some embodiments, a game may call for a user or student to generate one or more parameters that is not provided as an input to the user or student, or the student may be asked to use a mathematical function to generate a parameter that is not presented to the user or student. In some embodiments, the teacher's and the student's computer may be the same computer. In some embodiments the teacher or game creator may use a different computer than the student or player. One or both of the game creator's computer and the student or player's make be a single computer. One or both of the game creator's computer and the student or player's computer may be connected to a network, and an instance of the game or problem may be developed or generated on a first computer and transmitted to a second computer where the code for such game or instance may be further executed and displayed. In some embodiments, one or more graphical elements may be displayed with or in conjunction with the presenting of the instances of the game.

Embodiments of the invention may include an article such as a non-transitory computer or processor readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 227 may store executable code such that processor 225 is configured to carry out embodiments disclosed herein by executing code. Processor 225 may be configured to for example act as or perform the functions of modules and instances (e.g., sprites) as described herein.

Embodiments of the invention may include a method of generating instances of a math problem to be executed on a media device, where the method includes transmitting to, or receiving by, a processor one or more formulas, functions, principles or rules that include a way of solving the math problem; transmitting to or receiving by the processor a value defining a parameter of the instances of the problem, such as a number of instances to be generated or presented to a user; and generating an executable code for the instances. The generated code may include an instruction to present the instance to a user of the media device; a prompt to the user to input or enter a response to the instance; and an instruction to verify a correctness of the response or the user to the problem in the instance. Embodiments of the also generate and transmit or execute a code to present a graphic item along with the instance that is presented to the user on the media device.

### Computing Device Product

Another embodiment of the present invention provides a development platform including machine-readable executable code stored on or contained in a non-transitory storage medium for or readable by a computing device or processor, wherein the executable code, when executed by the computing device or processor, cause the computing device or processor to perform a method of the present invention as disclosed herein, including for example embodiments the method shown in FIG. 5, as described herein.

It will be appreciated by persons skilled in the art that embodiments of the invention are not limited by what has been particularly shown and described hereinabove. Rather the scope of at least one embodiment of the invention is defined by the claims below.

What is claimed is:

1. A method for automatically generating one or more instances of a predefined class of problem, the method comprising:
receiving, by a first computing device, at least one input parameter at least partially defining an instance of the predefined class;
responsively to the receiving, automatically generating, by the first computing device, at least one instance of the predefined class, according to the at least one input parameter, wherein:
the at least one instance includes executable code stored in a non-transitory storage, such that when the executable code is executed by a second computing device, the executable code causes the second computing device to:
present the at least one instance to a learner via the second computing device;
prompt the learner to enter at least one solution to the at least one instance; and
if the learner enters the at least one solution, automatically verify a correctness of the at least one solution.

2. The method of claim 1, wherein the second computing device is the same as the first computing device.

3. The method of claim 1, wherein the second computing device is different from the first computing device.

4. The method of claim 1, wherein at least one of the first computing or the second computing device is a single computing device.

5. The method of claim 1, wherein at least one of the first computing or the second computing device is connected via a data network.

6. The method of claim 1, wherein the at least one input parameter includes a value for determining a number of problems to be presented to the learner.

7. The method of claim 1, wherein the at least one input parameter is a limit of a random number.

8. The method of claim 1, wherein the at least one input parameter is a mathematical function for verifying a correctness of the at least one solution.

9. The method of claim 1, wherein the at least one input parameter specifies a prompt to the learner.

10. The method of claim 8, further comprising at least one of:
reporting the results of the verifying; and
informing the learner of the results of the verifying.

11. The method of claim 1, wherein the at least one instance is a plurality of instances.

12. The method of claim 11, wherein the instances of the plurality are unique.

13. The method of claim 1, wherein the at least one input parameter is a mathematical function for deriving a parameter that is not input.

14. The method of claim 1, wherein the at least one instance contains at least one graphical element for display in conjunction with the presenting of the instances to the learner.

15. A system for operating a media device, the system comprising:
a memory,
a processor configured to
receive at least one input parameter at least partially defining an instance of a predefined class of a problem;
automatically generate at least one instance of the predefined class of problem according to the at least one input parameter;
present the at least one instance to a learner;
prompt the learner to enter at least one solution to the at least one instance; and
if the learner enters the at least one solution, automatically verify a correctness of the at least one solution.

16. The system as in claim 15, wherein the at least one instance contains at least one graphical element for display in conjunction with the presenting of the instances to the learner.

17. A method of generating instances of a math problem to be executed on a media device, the method comprising:
receiving by a processor a formula, said formula including a subject of said math problem;
receiving by said processor a value defining a parameter of said instances;
generating an executable code for said instances, said code when executed by said processor to cause the processor to:
present said instance to a user;
prompt a user to input a response to said instance; and
verify a correctness of said response.

18. The method as in claim 17, comprising generating a graphic item for said instance and presenting said graphic item to said user along with said instance.
